(19) United States
(12) Patent Application Publication
(10) Pub. No.: US 2007/0296225 A1
(43) Pub. Date: Dec. 27, 2007

(54) LOCKING MECHANISM FOR A COMMUNICATIION DEVICE

(75) Inventors: Jeff W. Ashton, Sunrise, FL (US); Jean-Philippe J. Cantave, Boca Raton, FL (US); Frank Garcia, Miami, FL (US); Vance M. McGary, Miami, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: MOTOROLA, INC., Plantation, FL (US)

(21) Appl. No.: 11/421,358

(22) Filed: May 31, 2006

(51) Int. Cl. E05C 1/08; H01M 2/10

(52) U.S. Cl. 292/163; 429/100; 429/97

(57) ABSTRACT

A locking mechanism for a communication device (100) is provided by an access cover (102) having a simple user interface with rugged features that prevent the access door from detaching if the device is dropped. The access cover (102) includes a latch (106) movable vertically in up and down positions (112, 114) in combination with a slideable lock (110) movable horizontally in side to side positions, one of the side positions preventing up and down movement of the latch. A single lock icon (120) is disposed across the latch (106) and slideable lock (110) such that an unlocked position (118) is indicated when the latch moves up and down (112, 114), and a locked position (116) is indicated when the slideable lock (110) is slid to the side position that prevents up and down movement of the latch.

### FIELD OF THE INVENTION

The present invention relates generally to locking mechanisms and more specifically to locking mechanisms for communication device housings.

### BACKGROUND

Portable electronic devices having an access cover, such as a battery door or other user accessible cover, present design challenges requiring the combination of strong retention, ruggedness and a simple user interface. Strong retention features are desired to prevent the cover from detaching if the device is dropped, but these same features can make removal of the access cover far more difficult for the user. The design challenge is made all the more complicated when the removal direction of the cover is the same as the most common drop direction, i.e. bottom drop. Many products address the problem by changing the access cover removal axis so as not to coincide with the drop axis. In many cases however, this involves retaining the door to the product with a screw or a clip thereby increasing parts count, labor, cost and steps to be performed by the end user.

Accordingly, it would be beneficial to have an improved locking mechanism assembly for a communication device.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIGS. 1A, 1B and 1C show a communication device having a locking mechanism formed of an access cover in locked, unlocked, and unlocked retracted positions in accordance with the present invention;

FIG. 2 is an exploded view of the access cover with latch and locking portion in accordance with the present invention;

FIGS. 3 and 4 show isometric views of the latch in locked and unlocked positions in accordance with the present invention;

FIGS. 5 and 6 show first and second side views of the latch formed in accordance with the present invention;

FIGS. 7 and 8 show front and back views of the latch formed in accordance with the present invention;

FIGS. 9 and 10 show top and bottom views of the latch formed in accordance with the present invention; and

FIG. 11 shows a front view of the latch in the unlocked position in accordance with the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in apparatus components related to facilitating access to a communication device, for example to change out batteries or tune internal components, via an access cover having an improved user interface. The access cover formed in accordance with the present invention provides improved resiliency if the communication device is dropped, without the use of screws or clips. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

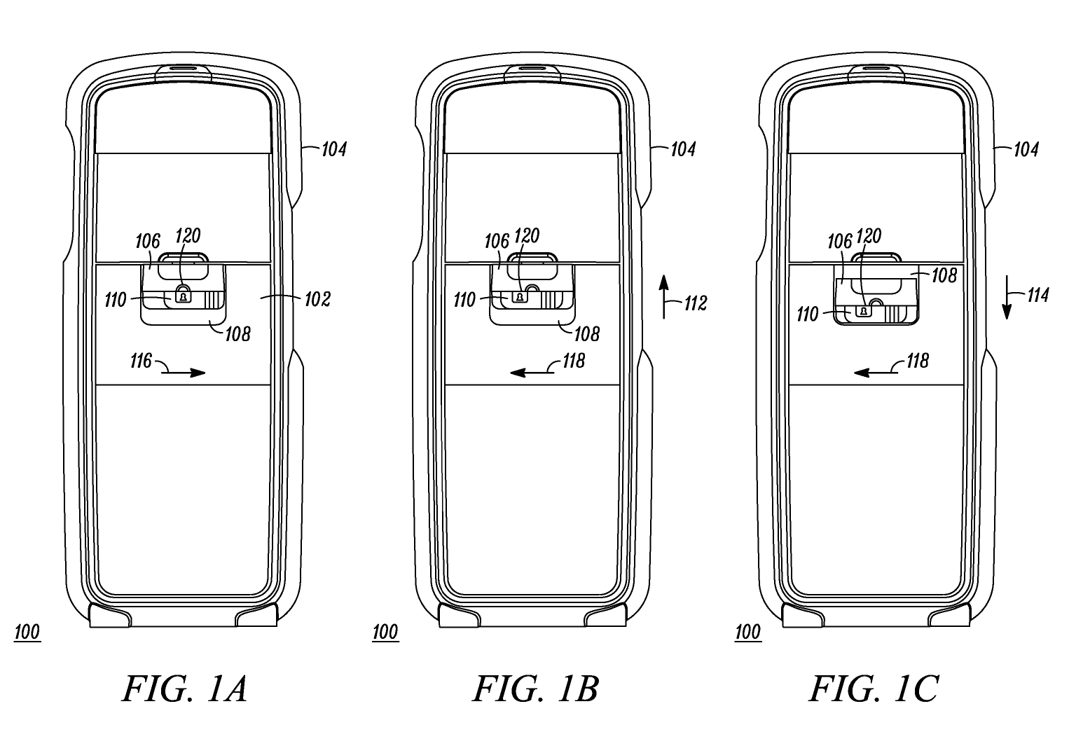

FIGS. 1A, 1B and 1C show a communication device 100, such as a two-way radio, cell phone, cordless land-line phone, personal digital assistant (PDA) or the like, having an access cover 102 formed in accordance with the present invention. Access cover 102 is removeably coupled to the device housing 104 via a latch 106 to provide an improved locking mechanism with a simple user interface for accessing internal compartments of the device without the use of screws, clips or tools while providing improved ruggedness if the device is dropped. The view of FIG. 1A shows the access cover 102 with latch 106 in a locked position 116 while the view of FIG. 1B shows the access cover 102 with the latch 106 in an unlocked position 118. The view of FIG. 1C shows the access cover 102 with the latch 106 in an unlocked position 118 and retracted within a user accessible recessed cavity 108 formed within the cover's surface.

As seen in FIGS. 1A, 1B and 1C, latch 106 includes a locking portion 110 movable horizontally side to side, in locked and unlocked positions 116, 118 respectively. In accordance with the present invention, and as seen in FIGS. 1B and 1C, the latch 106 is movable vertically in up and down positions 112, 114 when the locking portion 110 is in the unlocked position 118. The locking portion 110 will also be referred to as slideable lock 110. The up and down positions 112, 114 are used to couple the access cover 102 to the housing 104, and the side to side positions 116, 118 are used to lock and unlock the cover to/from the housing 104. In accordance with the present invention, a single lock icon 120 is disposed across the latch 106 and slideable lock 110 such that an unlocked position 118 is indicated by the icon when the latch is capable of moving up and down, and a locked position 116 is indicated by the icon when the slideable lock 110 is slid to a side position that prevents up and down movement of the latch.

Latch 106 is a spring loaded latch capable of being retracted into the recess cavity 108 by a user so as to couple the access door to the housing 104. The spring loaded latch is then released by the user to automatically engage the access cover 102 to the housing 104. The housing 104 also includes openings (not shown) for receiving the access cover 102.

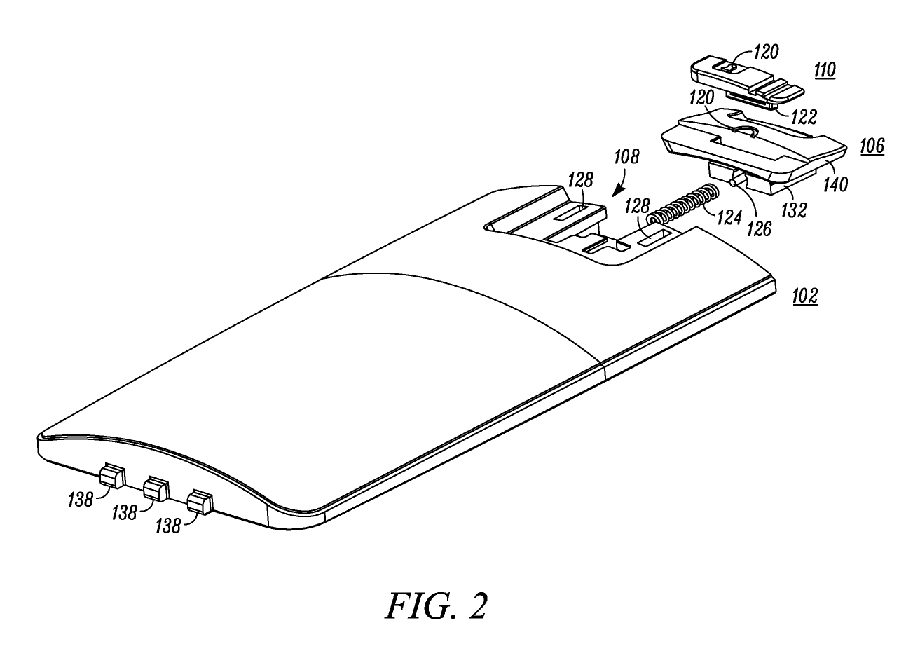

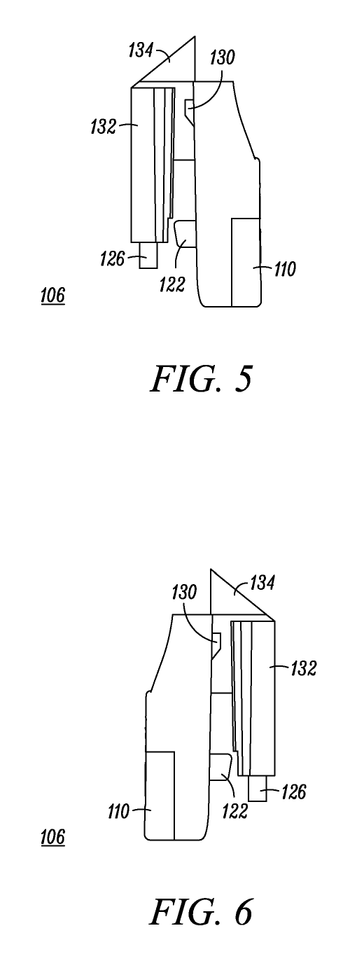

Referring to FIG. 2, an exploded view of access cover 102, latch 106 and locking portion 110 are shown. The remaining figures show various views of the latch 106 and will be referred to throughout the description. The locking portion 110 includes a tab 122 for coupling the locking portion to the latch 106 as will be shown in greater detail in FIGS. 5 and 6. A spring 124 is used to couple the latch 106 within the recessed cavity 108 of the access cover 102. Latch 106 also includes a post 126 with which to load the spring 124 to provide retractability within the user accessible recessed cavity 108. Alignment apertures 128 are provided within the recessed cavity 108 to receive guide ramps 130 (shown in FIGS. 5, 6, 8, 9 and 10) which are used to control and limit the amount of retraction of the latch 106 by the user. Alignment posts 138 are provided to the base of the access cover 102 and are used by the user to align the cover within the housing 104 (via corresponding openings, not shown, within the housing). The three pieces 102, 106, 110 shown in the exploded view are preferably formed as three plastic piece parts which, when assembled in conjunction with the spring, provide a completed access cover for use with housing 104 of communication device 100. This advantageous assembly eliminates the need for stiff springs thereby making the latch 106 easier for the user to retract.

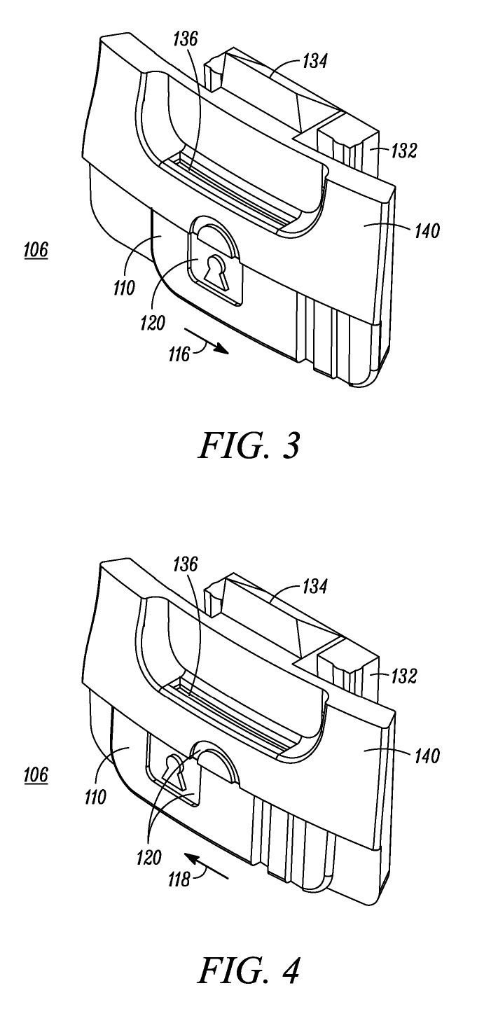

Referring to FIGS. 3 and 4, there are shown isometric views of latch 106 in locked and unlocked positions 116, 118 respectively. Latch 106 includes the slideable lock 110 coupled to the latch 106, the slideable lock is movable horizontally in side to side positions, one of the side positions, here locked position 116, prevents up and down movement of the latch when the latch is coupled within the access cover 102 (as seen in FIG. 1A). As mentioned above, when latch 106 is coupled within the access door 102, the latch can be retracted into the user accessible recessed cavity 108 (FIG. 1C) by the user and then released by the user to automatically engage the access cover to the housing 104. As further seen in the isometric views, latch 106 includes a back platform section 132 having a wedge 134 extending therefrom, the wedge 134 for inserting within an opening (not shown) of the communication device housing 104 when the latch is released by the user. A finger recess 136 is formed within the latch 106 to allow the user to retract the latch using a finger when the latch is in the unlocked position 118. The user pushes down at the finger recess 136 to retract the latch with wedge 134 within the recessed cavity 108 (shown in FIG. 1C and FIG. 2) of access cover 102. Once locked, the locking portion 110 assists the latch 106 in retaining the access cover 102 to the housing 104 if the communication device is dropped. The latch's use of combined vertical and horizontal assembly thus provides a simple user interface with ruggedness.

In use, the user takes an assembled access cover 102, inserts the alignment posts 138 into the housing 104, for example at a 45 degree angle, retracts the latch 106 such that the wedge 134 is pulled within the recessed cavity 108 with the icon indicating an unlocked condition 118, pushes the cover into the housing, releases the latch (thereby engaging the wedge 134 into the housing), and then slides the locking portion 110 such that the icon 120 indicates a locked position 116. To remove the access cover 102 from the housing 104, the user simply slides the locking portion 110 over such that the icon 120 indicates an unlocked position 118, retracts the latch 106 (thereby disengaging the wedge 134 from the housing 102) and pulls the cover away from the housing.

FIGS. 5 and 6 show first and second side views of the latch 106 in accordance with the present invention. In these views, the lock portion 110 is seen to include the tab 122 inserted through an opening (not shown) in the front platform 140. The front and back platforms 140, 132 are unitarily molded with the wedge 134 connecting the two platforms at the top and a gap being formed between the two platforms beneath the wedge. The back platform includes post 126, which as mentioned earlier, is used for insertion into spring 124.

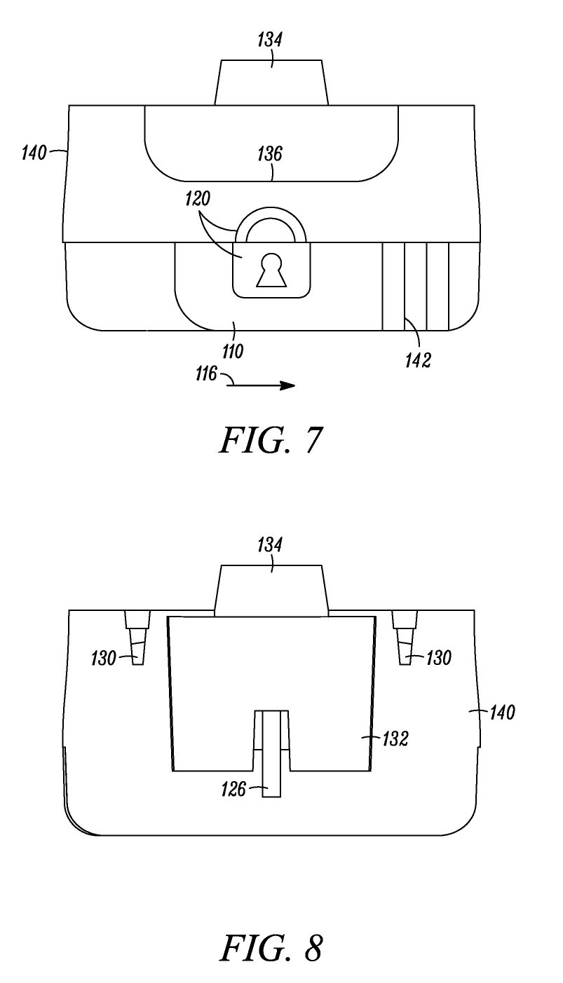

FIGS. 7 and 8 show front and back views of the latch 106 formed in accordance with the present invention. The locking portion 110 is slid over such that the icon 120 is shown in the locked position 116. Wedge 134 and finger recess 136 are shown on front platform 140. Finger grips 142 are preferably provided to the moveable sliding portion 110 to improve the tactile feel for the user. The back view of FIG. 8 shows the wedge 134 coupled between the front and back platforms 140, 132. Guide ramps 130 are coupled to the front platform 140 and post 126 is coupled to the back platform 132.

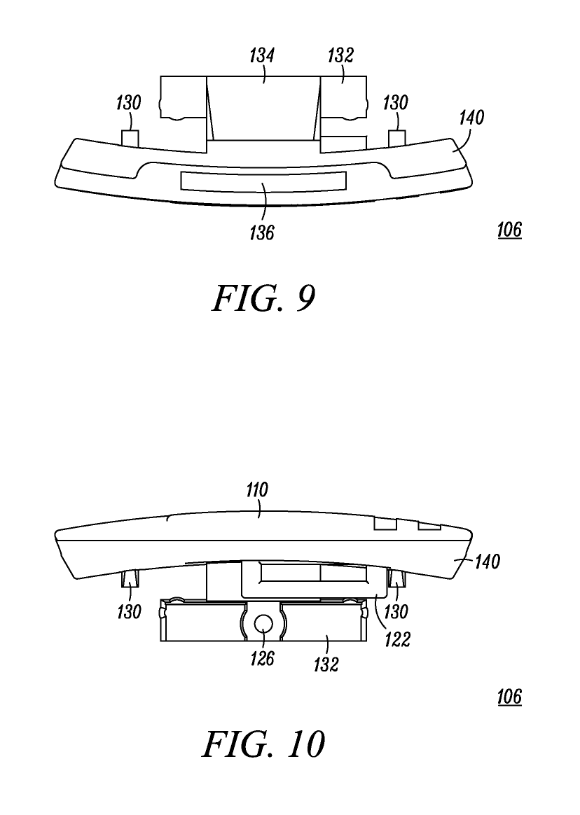

FIGS. 9 and 10 show top and bottom views of the latch 106 respectively. The front and back platforms 140, 132 are unitarily molded with a bridge formed of the wedge 134 therebetween creating a gap. In the top view, front platform 140 is shown coupled to back platform 132, the front platform including finger recess 136. In the bottom view, tab 122 of slideable lock portion 110 is shown protruding through the front platform 140 in the gap between the front and back platforms 140, 132. Tab 122 moves side to side within a slot as the slideable switch is slid by the user. Thus, the lock 110 moves slideably on the latch 106. Note that the latch 106 only moves vertically up and down when it is assembled as part of the access cover 102. The numerous views of the latch are provided to show examples of preferred latch details, but other configurations of spring loaded latches can be used without departing from the scope and spirit of the present invention. The locking mechanism of the present invention is a combination of retractable latch having vertical up and down forces combined with a slideable lock movable via horizontal forces which in conjunction with a single icon disposed thereon provide an intuitive easy to use user interface that allows easy user access to a housing while providing ruggedness to prevent detachment of the cover if the housing is dropped.

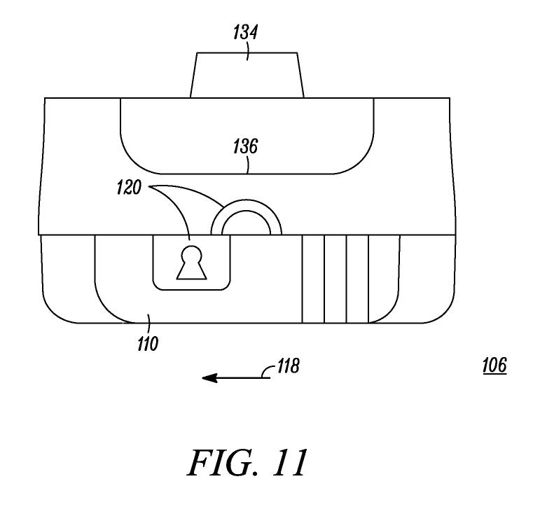

FIG. 11 shows a front view of the latch in the unlocked position in accordance with the present invention. The wedge 134, finger recess 136 and the single icon 120 are visible in this view. Lock portion 110 has been slid over such that the single icon 120 is shown in the unlocked position 118. The single icon 120 is partially disposed on the latch 106 and partially disposed on the slideable lock 110. The icon 120 can be painted, embossed, engraved or otherwise suitably disposed onto the latch 106.

Thus, there has been provided an access cover having a vertically retractable portion and horizontally slideable lock that prevents retraction when the latch is in a locked position. The latch assembly of the present invention avoids the use of stiff springs to keep the access door from becoming detached from the housing. By adding the locking mechanism to the latch assembly, an easy to use interface has been provided to the user along with improved ruggedness in case the housing is dropped.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. An access cover for a housing, the access cover including:
a latch movable vertically in up and down positions;
a slideable lock coupled to the latch, the slideable lock movable horizontally in side to side positions, one of the side positions preventing up and down movement of the latch; and
a single lock icon having a first icon portion disposed on the latch and a second icon portion disposed on the slideable lock, the first and second icon portions forming top and bottom halves of a padlock shape such that an unlocked padlock shape is formed when the latch moves up and down, and a single locked padlock shape is formed when the slideable lock is slid to the side position that prevents up and down movement of the latch and the first and second icon portions come together.

2. The access door of claim 1, wherein the latch is a spring loaded latch.

3. A locking mechanism for a housing, comprising:
an access cover having a recessed cavity formed therein;
a spring loaded latch, the spring loaded latch being retractable into the recess so as to couple the access cover to the housing, the spring loaded latch automatically engaging the access cover to the housing when released;
a slideable lock coupled to the spring loaded latch for preventing retraction of the latch when in a locked position, and the slideable lock allowing retraction of the latch when in an unlocked position;
a single icon for indicating the locked and unlocked positions, the single icon having a first icon portion disposed on the spring loaded latch representing a top half of a padlock shape, and a second icon portion disposed on the slideable lock representing a bottom half of the padlock shape; and
the first and second icon portions coming together to form a single padlock shape when the slideable lock is slid to the locked position, and the first and second icon portions being separated when the slideable lock is slid to the unlocked position.

4. The locking mechanism of claim 3, wherein the spring loaded latch presents forces in vertical up and down directions while the slideable lock presents forces in horizontal side to side directions.

5. A communication device, comprising:
a housing; and
an access cover for removable coupling to and from the housing, the access cover including a latch movable vertically in up and down positions and including a locking portion movable horizontally in side to side positions;
the up and down positions being used to couple the access cover to the housing and the side to side positions being used to lock the cover to the housing; and
a first icon portion disposed on the latch and a second icon portion disposed on the locking portion, an unlocked padlock shape being formed by the first and second icon portions being separated when the latch moves in the up and down positions, and a single locked padlock shape being formed when the locking portion is slid over to a side position that prevents up and down movement of the latch.

6. (canceled)

7. The communication device of claim 5, wherein the access cover provides a battery door cover for the communication device.

8. (canceled)

9. The communication device of claim 5, wherein the access cover includes a user accessible recessed cavity within which to vertically retract the latch in the down position.

10. The communication device of claim 9, wherein the latch includes a wedge, the wedge engaging the access cover to the housing when the latch is released.

11. The communication device of claim 10, wherein the latch further includes a finger recess, the finger recess providing a user interface for pulling down on the latch.

12. The communication device of claim 11, wherein the latch further includes guide ramps for aligning within alignment apertures of the access cover.

13. The communication device of claim 12, wherein the locking portion further includes finger grips to facilitate the side to side horizontal movement of the locking portion.

14. (canceled)

15. (canceled)
